(19) United States
(12) Patent Application Publication
(10) Pub. No.: US 2018/0299211 A1
(43) Pub. Date: Oct. 18, 2018

(54) METHOD FOR CORROSION PROTECTION OF TUBING BRAZE JOINTS THAT CONNECT COPPER AND ANODIC ALLOY TREATED ALUMINUM

(71) Applicant: Lennox Industries Inc., Richardson, TX (US)

(72) Inventor: Hermon Alan BOYD, Red Oak, TX (US)

(73) Assignee: Lennox Industries Inc., Richardson, TX (US)

(21) Appl. No.: 16/018,132

(22) Filed: Jun. 26, 2018

Related U.S. Application Data
(63) Continuation of application No. 14/674,719, filed on Mar. 31, 2015.

(51) Int. Cl. F28F 9/02; B23K 1/00

(52) U.S. Cl. CPC F28F 9/0256; B23K 1/0012; F28F 2275/04

(57) ABSTRACT

An apparatus and method for a brazed joint is described. A larger diameter pipe is brazed to a smaller diameter pipe. A flare is provided, extending from the end of the larger pipe toward the smaller pipe and radially outward. Such a flare protects the brazed joint from exposure to water and other elements and protects against corrosion. A sealant may also be added between the flare and the smaller pipe to add increased protection.

### CROSS-REFERENCED APPLICATIONS

This application is a continuation of U.S. patent application Ser. No. 14/674,719, filed on Mar. 31, 2015. U.S. patent application Ser. No. 14/674,719 is incorporated herein by reference.

### TECHNICAL FIELD

The present disclosure is directed to joints between dissimilar pipes and more particularly to brazed joints.

### BACKGROUND OF THE INVENTION

In air conditioning and heating systems there are various alloys and metals used for the different pipes, heat exchangers and other parts. The decision of what material to use in which section can depend on factors such as temperature, the type of fluid carried within the part, swelling from temperature changes, exposure to the elements and more. A common problem is how to join pipes or parts made from different materials. Because different materials swell differently, react to water or other substances differently and other factors, joints between two different materials can become sources of corrosion or wear. One common joint in heating and cooling systems is between aluminum and copper pipes.

Brazing is a typical method of joining two dissimilar pipes together. In brazing, a material of a lower melting point is heated and melted in an overlapping portion of the two dissimilar pipes, the larger diameter pipe placed around the smaller diameter pipe. The overlapping portion between the pipes is the site of the brazing. One common brazing alloy is aluminum 4047. The pipes, being of a higher melting point will not melt, but the brazing material will melt and then solidify, forming a strong bond between the two pipes.

At joints connecting two different pieces there is an increased risk of corrosion and galvanic corrosion. Joints provide seams and crevices into which water or other substances can enable erosion of the surrounding materials. One solution to the problem of galvanic corrosion is to provide a coating on the dissimilar pipes. Such coatings can be types of paints or elastomeric materials such as shrink wrap. However, these solutions can interfere with protective coatings on the surrounding pipes.

Aluminum, for example, because of its susceptibility to corrosion, is often given a diffused anodal alloy treatment for protection. Testing has shown that when an aluminum tube is being protected by this anodal treatment, paint is lifted from the surface as the alloy preferentially corrodes. When the paint lifts, it no longer provides galvanic corrosion protection at the copper-aluminum junction. This leaves the braze joint susceptible to shortened corrosion life resulting in non-reparable leaks.

In addition, treatments like shrink wrap may interact with the anodal protective coating. Testing has shown that the protective alloy corrodes under elastomeric seals, starting at the edge and tunneling under. After the corrosion process has tunneled sufficiently, a different corrosion mechanism, crevice corrosion, is enabled. This mechanism acts relatively quickly and creates a pit under the elastomeric material, leading to a non-reparable leak.

Especially problematic are brazed joints with a “short fuse.” This occurs when the brazing does not cover the entire overlapping surface area between the pipes, also called a partial fill. Corrosion works its way up the partial fill quicker than it would on a larger brazing surface.

### BRIEF SUMMARY OF THE INVENTION

An improved brazed joint is described for connecting pipes within a heating or cooling system. One advantage of the disclosure is a joint that is protective against galvanic and other types of corrosion. Another advantage is compatibility with anodal treatments or other coatings that are common on the surface of metal piping. Another advantage is that the joint prevents water and other materials from entering the brazed joint between dissimilar pipes where they can cause harmful corrosion. One embodiment is a downward opening flare in an aluminum tube at a copper-aluminum braze joint that acts as an umbrella to prevent ambient wetness from flowing across the braze joint galvanic couple, and also provides a faying volume allowing placement of an adhesive sealant to both the copper tube outside surface and the aluminum tube inside surface (where no anodal treatment has been applied), thus acting as a moisture barrier at the braze joint.

One embodiment comprises a brazed joint connecting an aluminum pipe of larger diameter to a copper pipe of smaller diameter wherein the aluminum pipe is vertically above the copper pipe, an improvement comprising: the aluminum pipe comprising a flare extending radially outward and toward the copper pipe, the flare operable to direct fluid away from the brazed joint.

Another embodiment comprises a brazed joint comprising: a first pipe; a second pipe, the second pipe comprising a flare, the flare extending outward radially and toward the first pipe and operable to direct fluid away from the brazed joint; and a brazing alloy, the brazing alloy connecting an inner surface area of the second pipe to an outer surface area of the first pipe.

Another embodiment comprises a method of connecting a larger diameter pipe to a smaller diameter pipe, comprising: brazing the pipes together with a brazing alloy, the brazing connecting an outer surface of the smaller pipe to an inner surface of the larger pipe; providing a flare, the flare extending from the larger pipe toward the smaller pipe and extending radially outward; and making the flare operable to direct fluid away from the brazed joint.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a diagram of the prior art.

FIG. 2 is a diagram of an embodiment of the disclosure.

FIG. 3A is a diagram of an alternate shape embodiment of the disclosure.

FIG. 3B is a diagram of an alternate shape embodiment of the disclosure.

FIG. 3C is a diagram of an alternate shape embodiment of the disclosure.

FIG. 3D is a diagram of an alternate shape embodiment of the disclosure.

FIG. 3E is a diagram of an alternate shape embodiment of the disclosure.

FIG. 4 is a diagram of an embodiment of the disclosure.

FIG. 5 is a flow-chart diagram of a method of practicing the disclosure.

FIG. 6 is a flow-chart diagram of a method of practicing the disclosure.

FIG. 7A is a diagram of a vertical embodiment of the disclosure.

FIG. 7B is a diagram of a horizontal embodiment of the disclosure.

### DETAILED DESCRIPTION OF THE INVENTION

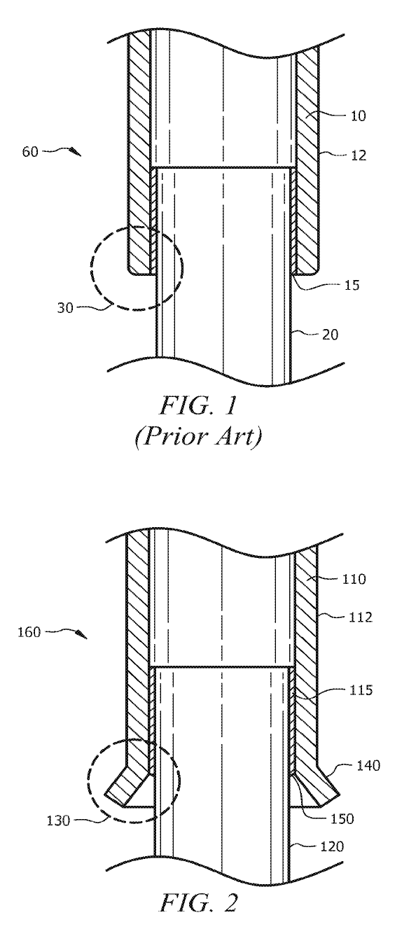

FIG. 1 shows an embodiment of a prior art brazed joint between a copper pipe 20 and an aluminum pipe 10. Aluminum pipe 10 may lead to a heat exchanger or other section of a heating or cooling system. Copper pipe 20 may lead to a refrigerant or water supply or other part of the heating or cooling system. Shrink wrap around the pipes would help protect against corrosion but aluminum pipe is often anodally treated to protect it from the elements. The anodal treatment 12 is usually just on the outside surface of aluminum pipe 10. The anodal treatment may make the pipe ill suited for shrink wrap or other processes to protect the joint. As shown in FIG. 1, copper pipe 20 and aluminum pipe 10 are joined by a braze alloy 15. The braze alloy 15 will be a material with a lower melting point than either aluminum or copper such as aluminum 4047 or ZA-1. During brazing the braze alloy is melted and used to bond the copper and aluminum pipes, which do not melt at the brazing temperature. Braze alloy 15 permits a strong bond but the bonding area 30 is exposed to the elements and substances, that when combined with water, can begin to corrode the joint. For example, if there is a lot of condensation on aluminum pipe 10 then the condensate and any ions contained therein will drip downward on pipe 10 and come into contact with brazing 15 and bonding area 30. These can increase the rate of corrosion as materials enter the border areas between the brazing and the aluminum and between the brazing and the copper. Such boundary areas can be the site where corrosion can occur as water and other substances enter and enable reactions between the aluminum, brazing and copper.

FIG. 2 shows a preferred embodiment according to the concepts described herein of a flared joint to help protect the joint from corrosion. Joint 160 combines an aluminum pipe 110 and a copper pipe 120. Aluminum pipe 110 has a zinc anodal coating 112 on its outer surface. Brazing alloy 115 bonds the pipes 110, 120 together. Downward opening flare 140 extends out from aluminum pipe 110. This setup provides a small fillet 150 on brazing 115. Bonding area 130 is thus protected from the elements and any moisture that drips downward from aluminum pipe 110.

The preferred embodiment is for a joint between copper and aluminum pipes. Copper and aluminum are common materials used in heating and air condition systems. Areas of condensation within these systems cause water to bead up on the exterior of some pipes. Condensed water may contain ions. The water then drips along the exterior of the pipes and can pick up additional ions from aluminum, copper or other metals while it falls and travels down the pipes. These ions in moisture can be particularly harmful to joints or other connection sites, increasing the risk of galvanic corrosion. For example, copper ions can be detrimental to aluminum. The preferred embodiment therefore helps prevent corrosion enabling ions from coming into contact with and potentially harming the braze joints between aluminum and copper piping. However, the ideas described can be used for joints between pipes of various materials with various types of coatings. Various brazing alloys can be used. One or both of the pipes may have anodal coatings such as zinc or other treatments. In some situations the teachings may be used for joints between pipes of the same material to provide extra corrosion protection.

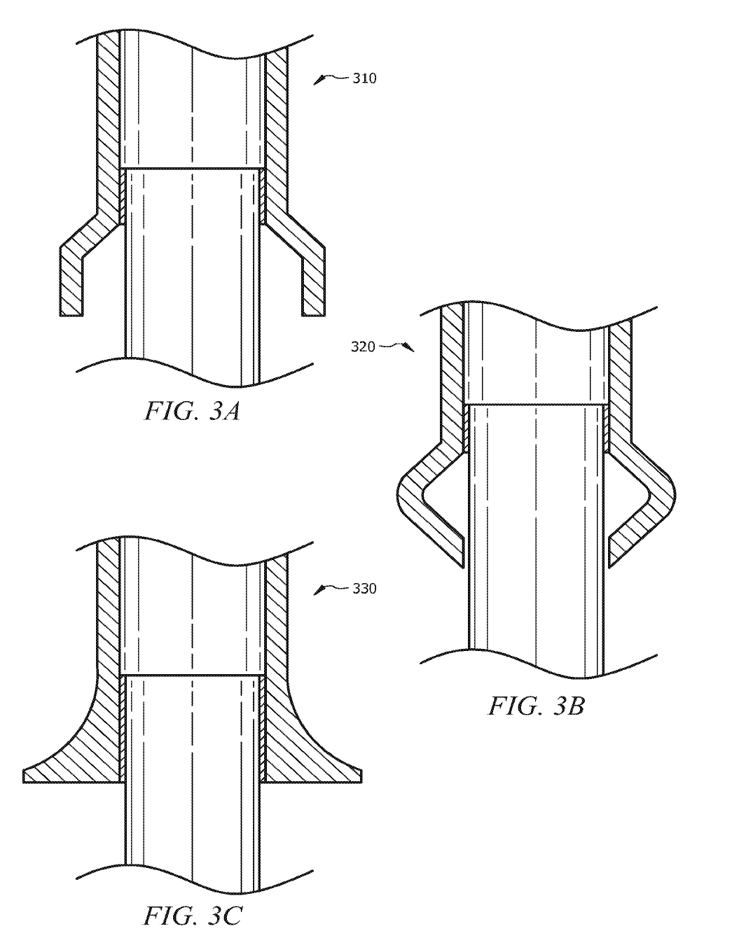

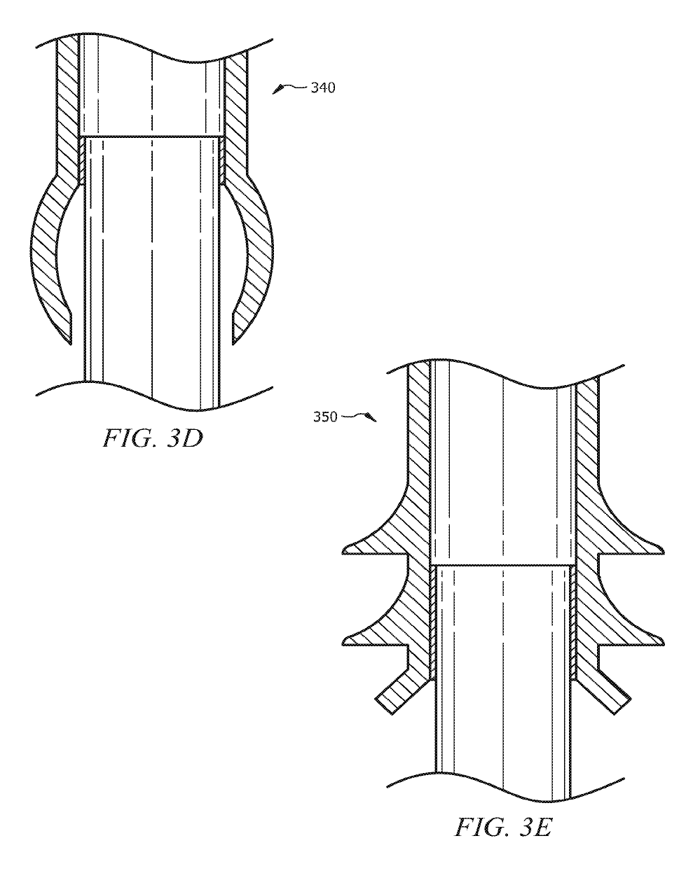

The flare described does not have to be of a particular shape. FIGS. 3A-3E show a variety of flare embodiments 310-350. The preferred shape of flare may depend on the unique circumstances of the surrounding heating or cooling system and other factors such as cost of manufacture. The flare can take any shape that helps divert water and other substances away from the joint area. The flare can vary in size. In most cases the size or length of the flare will depend on the size of the brazed joint and pipes. Depending on the size of the joint and pipes, the flare will have to extend enough over the joint to protect the joint from corrosion.

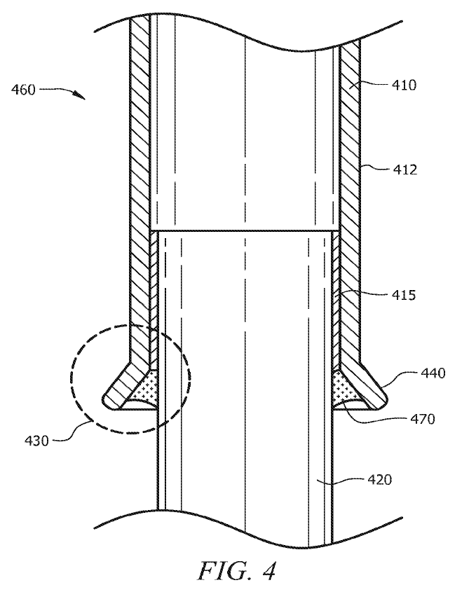

For increased protection from corrosion, a sealant 470 may be used as shown in FIG. 4. FIG. 4 shows an embodiment similar to FIG. 2, but with the inclusion of sealant 470 between flaring 440 and copper pipe 420. Sealant 470 will be adhesive and adhesively bond to the space between flaring 440, brazing 415 and copper pipe 420. A preferred embodiment of sealant 470 is made of silicon but other materials can be used as well. Adhesives, paints, and shrink wraps have deleterious effects on anodally treated aluminum piping such as pipe 410. However, aluminum piping is usually only treated on the exterior surface. Sealant 470 can be attached to the inner face of aluminum pipe 410 which is not anodally treated. Heating and cooling systems that run cold, e.g. below the dew point, will especially need sealant 470 to protect the joint 460. Units that run hot may not have as much condensation, but sealant 470 can still provide needed protection from corrosion.

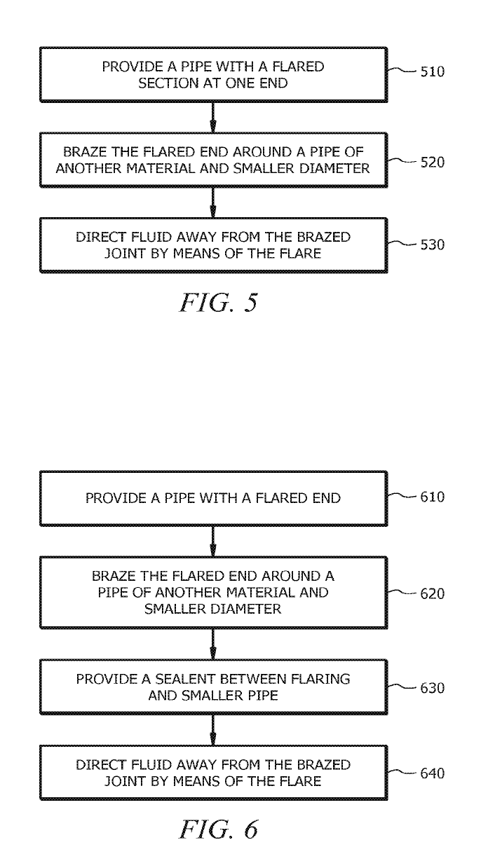

FIG. 5 discloses a method for creating a flared joint. A first pipe is provided with a flared end section 510. The flared end is then brazed to connect to a smaller pipe of a different material 520. Fluids are then directed away from the brazed joint by the flare 530.

FIG. 6 shows another embodiment of a method for producing a flared joint. A first pipe is provided with a flared end section 610. The pipe is then brazed to connect to a smaller pipe of a different material 620. A sealant is then provided between the flaring, the brazing and the smaller pipe 630. Fluid is then directed away from the brazed joint by the flare 640.

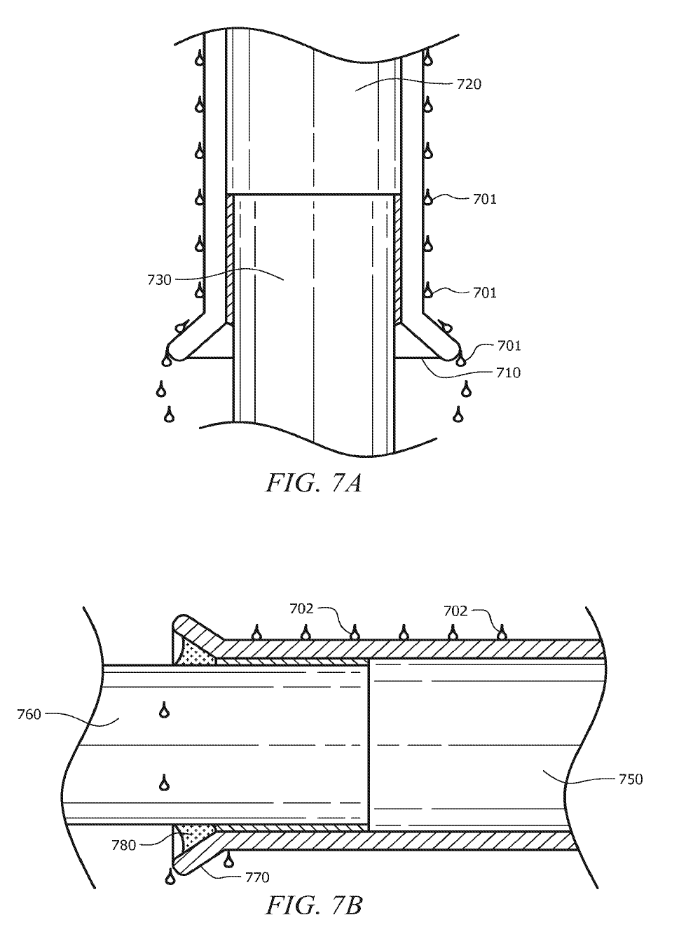

The preferred embodiment, shown in FIG. 2 is a situation where the aluminum pipe is vertically above the copper pipe. However, certain situations may necessitate other geometries where the joint is horizontally disposed or at various angles. Different geometrical embodiments may necessitate the use of various flare shapes, as discussed supra. FIG. 7A shows a preferred embodiment in which fluid 701 falls vertically down a pipe 720 and is directed away from the brazed joint by a flare 710. FIG. 7B shows another embodiment comprising a horizontal joint between pipes 750 and 760. Fluid 702 is directed away from the joint by flare 770 and sealant 780.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1-4. (canceled)

5. A brazed joint comprising:
a first pipe comprising an end having an outer diameter;
a second pipe comprising:
an end having an inner diameter configured to receive the end of the first pipe; and
a flared portion comprising a first portion that extends radially away from a centerline of the second pipe and a second portion that extends radially toward the centerline of the second pipe; and
a brazing alloy, the brazing alloy connecting an inner surface area of the second pipe to an outer surface area of the first pipe.

6. The brazed joint of claim 5, wherein the flared portion comprises an arc-shaped cross-section.

7. The brazed joint of claim 5, wherein the first and second portions comprise a conical shape.

8. The brazed joint of claim 5, further comprising a silicon sealant between the inner surface area of the second pipe and the outer surface area of the first pipe.

9. The brazed joint of claim 5, wherein the second pipe comprises aluminum.

10. The brazed joint of claim 5, wherein the first pipe comprises copper.

11. The brazed joint of claim 5, wherein an outer surface of the second pipe comprises an anodal treatment.

12. The brazed joint of claim 5, wherein the second pipe comprises a zinc coating.

13. A brazed joint comprising:
a first pipe comprising an end having an outer diameter;
a second pipe comprising:
an end having an inner diameter configured to receive the end of the first pipe; and
a flared portion comprising a plurality of flares; and
a brazing alloy, the brazing alloy connecting an inner surface area of the second pipe to an outer surface area of the first pipe.

14. The brazed joint of claim 13, wherein:
the plurality of flares comprise three flares; and
each flare comprises a portion that extends radially away from the second pipe.

15. The brazed joint of claim 14, wherein two of the three flares comprise a curved-conical face.

16. The brazed joint of claim 15, wherein one of the three flares comprises a flat-conical face.

17. The brazed joint of claim 13, further comprising a silicon sealant between the inner surface are a of the second pipe and the outer surface area of the first pipe.

18. The brazed joint of claim 13, wherein the second pipe comprises aluminum.

19. The brazed joint of claim 13, wherein the first pipe comprises copper.

20. The brazed joint of claim 13, wherein an outer surface of the second pipe comprises an anodal treatment.

21. The brazed joint of claim 13 wherein the second pipe comprises a zinc coating.
